(19) United States
(12) Patent Application Publication
(10) Pub. No.: US 2025/0076997 A1
(43) Pub. Date: Mar. 6, 2025

(54) METHOD, APPARATUS, DEVICE AND STORAGE MEDIUM FOR POSITIONING AN ENTITY CONTROLLER

(71) Applicant: Beijing Zitiao Network Technology Co., Ltd., Beijing (CN)

(72) Inventors: Hanzhen LI, Beijing (CN); Junliang SHAN, Beijing (CN); Tao WU, Beijing (CN); Tao ZHANG, Beijing (CN)

(21) Appl. No.: 18/819,610

(22) Filed: Aug. 29, 2024

(30) Foreign Application Priority Data
Aug. 31, 2023 (CN) 202311117959.9

(51) Int. Cl. G06F 3/0346; G06T 7/73

(52) U.S. Cl. CPC G06F 3/0346; G06T 7/74; G06T 2207/10144; G06T 2207/30196

(57) ABSTRACT

The embodiment of this application provides a method and apparatus for positioning an entity controller, device and a storage medium. The method includes following steps: determining a relative pose relationship between an entity controller and an associated part of the entity controller, the relative pose relationship being determined from at least one entity controller pose and at least one associated part pose, the entity controller pose being determined from a first type of image, the associated part pose is determined from a second type of image, and the first type of image and the second type of image using different exposure policies; determining a current associated part pose, the current associated part pose being determined based on a current second type of image that is closest to the current; and determining an estimate pose of the entity controller based on the relative pose relationship and the current associated part pose.

### CROSS-REFERENCE

The present application claims priority to Chinese Patent Application No. 202311117959.9, filed on Aug. 31, 2023 and entitled “METHOD, APPARATUS, DEVICE AND STORAGE MEDIUM FOR POSITIONING AN ENTITY CONTROLLER”, the entirety of which is incorporated herein by reference.

### FIELD

Embodiments of the present application relates to a technical field of data processing, in particular to a method, an apparatus, a device and storage medium for positioning an entity controller.

### BACKGROUND

At present, an application scenario of an extended reality (Extended Reality, XR for short) technology is more and more widely used, and specifically includes Virtual Reality (VR), Augmented Reality (AR), Mixed Reality (MR for short), and the like. To ensure a real motion experience of a user in a virtual scene, a XR device usually configures a corresponding entity controller, for example, a handle, a finger ring, a body tracker, and the like, and performs positioning and tracking on the head-mounted display and each entity controller in the XR device, to simulate a motion behavior of the user in the virtual scene.

Generally, corresponding optical devices may be provided in the head-mounted display and each entity controller to analyze pose information of each entity controller in an optical positioning and tracking manner. However, when the user uses the entity controller to perform some relatively large actions, the entity controller may be occlusion by a body part of the entity controller, but cannot perform optical positioning and tracking on the entity controller, so that the positioning of the entity controller has certain limitations.

### SUMMARY

Embodiments of the present application provide a method, an apparatus, a device and storage medium for positioning an entity controller, which realize an accurate positioning of the entity controller, provide a wider positioning range for the entity controller, reduce a positioning blind area when the entity controller is occlusion, and improve the positioning stability of the entity controller.

According to a first aspect, the embodiments of the present application provide a method for positioning an entity controller, and the method includes:
determining a relative pose relationship between the entity controller and an associated part of the entity controller, the relative pose relationship being determined from at least one entity controller pose and at least one associated part pose, the entity controller pose being determined from a first type of image, the associated part pose is determined from a second type of image, and the first type of image and the second type of image using different exposure policies;
determining a current associated part pose, the current associated part pose being determined based on a current second type of image that is closest to the current;
determining an estimated pose of the entity controller based on the relative pose relationship and the current associated part pose.

According to a second aspect, the embodiments of the present application provide an apparatus for positioning an entity controller, and the apparatus includes:
a relative pose determination module, configured to determine a relative pose relationship between the entity controller and an associated part of the entity controller, the relative pose relationship is determined from at least one entity controller pose and at least one associated part pose, the entity controller pose is determined from a first type of image, the associated part pose is determined from a second type of image, and the first type of image and the second type of image use different exposure policies;
an associated part positioning module, configured to determine a current associated part pose, the current associated part pose is determined based on a current second type of image that is closest to the current; and
an entity positioning module, configured to determine an estimated pose of the entity controller based on the relative pose relationship and the current associated part pose.

According to a third aspect, the embodiments of the present application provide an electronic device, and the electronic device includes:
a processor and a memory for storing a computer program, and the processor is configured to invoke and run the computer program stored in the memory, to perform the method for positioning the entity controller as provided in the first aspect of the present application.

According to a fourth aspect, the embodiments of the present application provide a computer-readable storage medium, configured to store a computer program, where the computer program causes a computer to perform the method for positioning the entity controller as provided in the first aspect of the present application.

According to a fifth aspect, the embodiments of the present application provide a computer program product, including a computer program/instructions, wherein the computer program/instructions cause a computer to perform the method for positioning the entity controller as provided in the first aspect of the present application.

According to technical scheme of this application, the first type of image and the second type of image are determined by using different exposure policies, and the relative pose relation between the entity controller and the associated part of the entity controller is determined from at least one entity controller pose determined from the first type of image and at least one associated part pose determined from the second type of image. Then, the current associated part pose is determined based on the current second type of image that is closest to the current, so that the estimated pose of the entity controller is determined based on the relative pose relationship and the current associated part pose, accurate positioning of the entity controller is achieved, a position that the entity controller cannot be positioned when the entity controller is occlusion is avoided, the associated part positioning the entity controller is combined, a wider positioning range is provided for the entity controller, a positioning blind area when the entity controller is occlusion is reduced, and stability and comprehensiveness of positioning of the entity controller are improved.

### BRIEF DESCRIPTION OF DRAWINGS

In order to more clearly illustrate technical solutions in the embodiments of the present application, drawings that need to be used in description of the embodiments are briefly described below, and obviously, the drawings in following description are merely some embodiments of the present application, and for those of ordinary skill in the art, other drawings may be obtained based on these drawings without creative work.

FIG. 1 is a flowchart of a method for positioning an entity controller provided by embodiments of the present application;

FIG. 2 is a principle schematic diagram of an overall positioning process of an entity controller provided by embodiments of the present application;

FIG. 3 is a principle schematic diagram of a positioning process when an entity controller is occlusion provided by embodiments of the present application;

FIG. 4 is a principle block diagram of a positioning apparatus of an entity controller provided by embodiments of the present application;

FIG. 5 is a schematic block diagram of an electronic device provided by embodiments of the present application.

### DETAILED DESCRIPTION

The technical solutions in the embodiments of the present application are clearly and completely described below with reference to drawings in the embodiments of the present application. All other embodiments obtained by those skilled in the art without creative efforts shall fall within a scope of the present application.

It should be noted that terms “first”, “second”, and the like in specification and claims of the present application and foregoing drawings are used to distinguish similar object, and are not necessarily used to describe a specific order or sequence. It should be understood that such used data may be interchanged where appropriate so that embodiments of the present application described herein can be implemented in an order other than those illustrated or described herein. In addition, the terms “comprising” and “having” and any deformation thereof are intended to cover a non-exclusive inclusion, e.g., a process, method, system, product, or server containing a series of steps or units not necessarily limited to those steps or units expressly listed, but may include other steps or units not expressly listed or inherent to such processes, methods, products, or devices.

In the embodiments of the present application, words such as “exemplary” or “for example” are used to indicate examples, illustrations, or descriptions, and any embodiment or solution described as “exemplary” or “for example” in the embodiments of the present application should not be construed as being more preferred or advantageous than other embodiments or solutions. Rather, words such as “exemplary” or “for example” are intended to present related concept in a specific manner.

In order to solve the problem that an entity controller configured by an XR device cannot perform optical positioning on the entity controller when performing some large actions, an inventive concept of the present application is to determine a first type of image and a second type of image by using different exposure policies, and determine a relative pose relationship between an entity controller and an associated part of the entity controller by using at least one entity controller pose determined from the first type of image and at least one associated part pose determined according to the second type of image. Then, the current associated part pose is determined based on the current closest current second type of image, so that the estimated pose of the entity controller is determined based on the relative pose relationship and the current associated part pose, accurate positioning of the entity controller is achieved, a position that the entity controller cannot be positioned when the entity controller is occlusion is avoided, the associated part positioning the entity controller is combined, the wider positioning range is provided for the entity controller, a positioning blind area when the entity controller is occlusion is reduced, and stability and comprehensiveness of positioning of the entity controller are improved.

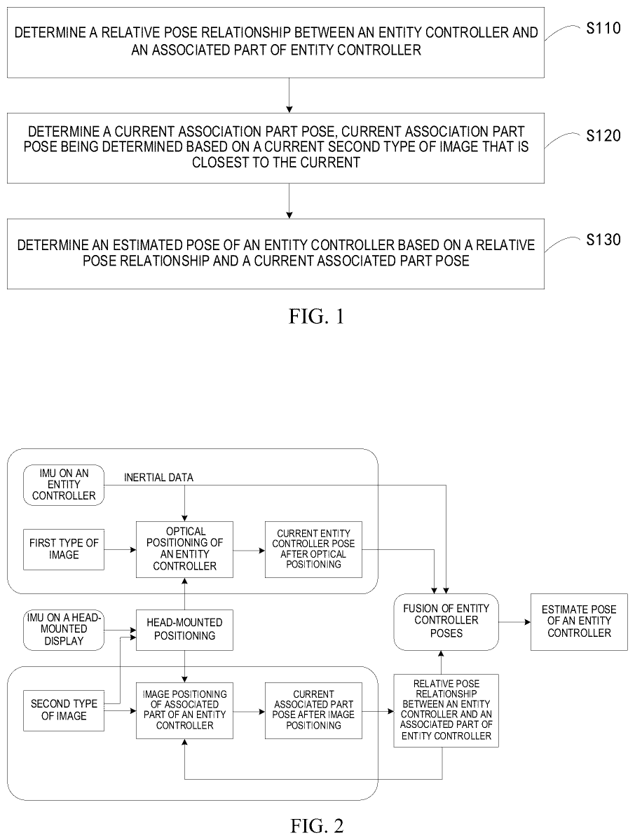

FIG. 1 is a flowchart of a method for positioning an entity controller provided by embodiments of the present application. The method may be performed by an apparatus for positioning the entity controller provided by the present application, wherein the apparatus for positioning the entity controller may be implemented in any software and/or hardware manner. For example, the apparatus for positioning the entity controller may be configured in an electronic device capable of simulating a virtual scene, such as an AR/VR/MR, which is not limited in the present application.

Specifically, as shown in FIG. 1, the method may include following steps:

S110, determining a relative pose relationship between the entity controller and an associated part of the entity controller.

To ensure convenient movement of a user in a virtual scene, a XR device usually configures a corresponding entity controller, such as a handle, a finger ring, a body tracker, and the like. The user wears or holds each entity controller on a corresponding body part, for example, a hand, a finger or a body torso, to drive each entity controller to perform various motion control operations, so as to perform positioning and tracking on each entity controller to implement various interaction of the user in the virtual scene.

Generally, when positioning and tracking each entity controller, a head-mounted display of the XR device uses a Simultaneous Localization And Mapping (SLAM) technology to determine a corresponding head-mounted pose, so as to realize a positioning of the head-mounted display. When positioning and tracking each entity controller, the entity controller pose and the associated part pose of the entity controller in the present application may be a relative pose of the entity controller and the associated part relative to the head-mounted display, that is, a pose in a head-mounted coordinate system, or after the relative pose of the entity controller and the associated part relative to the head-mounted display is calculated, the pose of the head-mounted display is further used to convert the relative pose of the entity controller and the associated part relative to the head-mounted display to obtain a real pose of the entity controller and the associated part in a world coordinate system.

In order to realize optical positioning and tracking of the XR device to the entity controller, a plurality of light-emitting elements, such as an infrared light source and the like, may be set on the entity controller. Moreover, a corresponding camera, such as an infrared camera, may be provided on the head-mounted display of the XR device to continuously capture the entity controller in a motion process, so as to perform the optical positioning and the tracking thereon.

In a process that the user drives the entity controller to move through a corresponding body part, the entity controller may be occlusion, and the entity controller cannot perform the optical positioning thereon. Moreover, the entity controller is usually fixedly worn or held on a corresponding body part of the user, and the entity controller is usually occlusion by the body part during the movement process. Generally, there is a relatively fixed association relationship between each entity controller and a body part wearing or holding the entity controller in a space structure.

Therefore, in order to solve a problem that the optical positioning cannot be performed on the entity controller when the entity controller is occlusion, for each entity controller configured by the XR device, a body part of the entity controller can be worn or held as an associated part of the entity controller. Then, the positioning and the tracking of the entity controller is realized by positioning and tracking associated parts of each entity controller and combining a relatively fixed association relationship therebetween.

For example, assuming that the entity controller is a handle, an association part of the entity controller may be a hand. A position tracking of the handle is realized by analyzing a pose of the hand and combining a relative grip pose between the two when the handle is held by the hand.

Therefore, in order to realize the positioning and the tracking of the entity controller, considering that the entity controller does not always be occlusion in the motion process, the present application may capture the first type of image of the entity controller in real time, and use an optical positioning algorithm to complete a successful optical positioning of the entity controller in the first type of image at at least one moment, thereby determining at least one entity controller pose.

The entity controller is provided with at least one light-emitting element, and the first type of image captured by the entity controller may include a light spot formed by each light-emitting element disposed on the entity controller. Further, the present application may use the optical positioning algorithm to analyze a light spot information in the first type of image at the at least one moment, thereby achieving the successful optical positioning of the entity controller. It may be learned that the at least one entity controller pose in the present application may be determined based on the light spot in the at least one first type of image. It may be understood that, to enable a light spot formed by each light-emitting element disposed on the entity controller to be captured in the first type of image, a light-emitting time of each light-emitting element set on the entity controller may be controlled to be matched with a capture time of the first type of image.

Moreover, for each entity controller, the present disclosure may also capture an association part of the entity controller in real time to obtain a second type of image. Then, an image positioning algorithm may perform positioning and tracking on the associated part of the entity controller in each of the second type of images to complete a successful positioning of the associated part in the second type of image at the at least one moment, to determine at least one associated part pose.

In the present application, in the at least one entity controller pose and the at least one associated part pose, the entity controller pose and the associated part pose at the same moment may be found. Then, the relative pose relationship between the entity controller and the associated part of the entity controller may be determined by analyzing a transformation relationship between the entity controller pose and the associated part pose at the same moment.

It may be understood that, since there is a relatively fixed association relationship between the entity controller and the associated part in aspatial structure, in order to ensure accurate identification of the associated parts in the first type of image and the second type of image, different exposure policies may be used to capture the entity controller.

For the first type of image captured by using a certain exposure strategy, when the entity controller is not occlusion, the light spot formed by the light emitting element provided on the entity controller can be clearly displayed in the first type of image, so as to realize the optical positioning of the entity controller. For the second type of image captured by another exposure strategy, the association part of the entity controller can be clearly displayed in the second type of image, so as to realize an image positioning of the associated part.

It can be understood that the positioning of the entity controller is realized by the light spot in the first type of image, and the relative pose relationship between the entity controller and the associated part can be more accurately calculated on the basis of less computation overhead in combination with the positioning of the associated part in the second type of image.

In some implementations, for the first type of image, in order to ensure that the light spot emitted by each light-emitting element on the entity controller is accurately capture, the present disclosure may set a first exposure duration for the camera on the head-mounted display, and the first exposure duration may be a relatively small determination value. Therefore, if the camera on the head-mounted display uses the first exposure duration to capture the entity controller, the first type of image at the low exposure level can be obtained, and when the entity controller is not occlusion, a background picture of the entity controller can be weakened, and the light spot formed by each light-emitting element on the entity controller is clearly captured, so as to ensure an optical positioning accuracy of the entity controller.

Moreover, for the second type of image, in order to ensure that the association part of the entity controller is accurately capture, the present application may further set a second exposure duration for the camera on the head-mounted display, where the second exposure duration is a larger value dynamically changed based on an ambient light brightness, so that the second exposure duration can be greater than the first exposure duration as a whole. Therefore, if the camera on the head-mounted display performs capturing on the entity controller by using the second exposure duration, the second type of image with a higher exposure degree can be obtained, and when the entity controller is occlusion, the background picture of the entity controller can be clearly captured, so that the associated part of the entity controller can be clearly displayed in the second type of image, so that the associated part of the entity controller is subsequently identified and positioned, and the positioning and tracking when the entity controller is occlusion is assisted.

It can be understood that the second type of image can clearly show actual objects in a scene. Therefore, the head-mounted display of the XR device may use the second type of image as the corresponding environmental image, and analyze the second type of image by using the SLAM technology, so as to combine inertial data continuously captured by the head-mounted display to determine the head-mounted pose of the head-mounted display in real time, to realize the positioning of the head-mounted display.

S120, determining a current association part pose, the current association part pose being determined based on a current second type of image that is closest to the current.

In order to ensure accurate positioning of the entity controller when being occlusion, considering that the association part of the entity controller is clearly shown in the second type of image, the present application may obtain a current second type of image that is closest to the current based on the capture time of each second type of image. Then, the image positioning algorithm is used to perform positioning and tracking on the association part of the entity controller in the current second type of image to obtain the corresponding current association part pose.

Specifically, for the current second type of image obtained each time, the present application may perform a corresponding feature analysis on the associated part of the entity controller in the current second type of image to extract key point features of the associated part of the entity controller. Then, through the image positioning algorithm, corresponding positioning analysis may be performed on the key point features of the associated part to determine a pose information of the associated part in the current second type of image as the current associated part pose in the present application.

For example, in order to ensure a positioning accuracy of the associated part in the second type of image, the present application may pre-train a neural network model, and the neural network model may perform key point feature analysis on a target object in any image, to implement positioning and tracking of the target object. Therefore, in the present application, the current second type of image may be input into the trained neural network model, and the key point feature analysis is performed on the associated part in the current second type of image by using the neural network model, so as to output a pose information of the associated part in the current second type of image, to obtain the current associated part pose in the present application.

S130, determining an estimated pose of the entity controller based on the relative pose relationship and the current associated part pose.

For the associated part of each entity controller, after the current associated part pose is determined, in order to achieve accurate positioning of the entity controller when being occlusion, the present application may perform corresponding pose transformation on the current associated part pose by using a predetermined relative pose relationship between the entity controller and the associated part, to obtain a pose information of the entity controller at the same moment at which the current associated part pose is located, and use the pose information as the estimated pose of the entity controller in the present application, thereby achieving accurate positioning of the entity controller when the entity controller is occlusion.

According to the technical scheme provided by the embodiments of the present application, the first type of image and the second type of image are determined by using different exposure policies, and the relative pose relationship between the entity controller and the associated part of the entity controller is determined from at least one entity controller pose determined from the first type of image and at least one associated part pose determined from the second type of image. Then, the current associated part pose is determined according to the current closest current second type of image, so that the estimated pose of the entity controller is determined from the relative pose relationship and the current associated part pose, the accurate positioning of the entity controller is achieved, the position that the entity controller cannot be positioned when the entity controller is occlusion is avoided, the associated part positioning the entity controller is combined, the wider positioning range is provided for the entity controller, the positioning blind area when the entity controller is occlusion is reduced, and the stability and the comprehensiveness of positioning of the entity controller are improved.

According to the present application, the optical positioning algorithm of the entity controller can be combined with a positioning of the associated part of the entity controller, so that accurate positioning of the entity controller can be realized comprehensively. The first type of image does not detect a light spot formed by each light-emitting element on the entity controller, indicating that the entity controller is occlusion. Therefore, the present application needs to perform position tracking on the entity controller by means of the pose information of the associated part of the entity controller and the relative pose relationship between the two.

In order to ensure the positioning accuracy of the entity controller, the present application generally sets an Inertial Measurement Unit (IMU) on the entity controller, and the IMU may use a higher frequency to detect the three-axis angular velocity and acceleration of the entity controller in the motion process in real time, so as to obtain IMU data of the entity controller, that is, the inertial data in the present application.

Since a detection frequency of the IMU is higher than an acquisition frequency of the camera on the head-mounted display for the entity controller and the associated part. Therefore, in a time interval between any two images in the first type of image and the second type of image, the IMU may generally detect a plurality of inertial data of the entity controller, thereby representing an amount of pose change of the entity controller in the time interval.

It may be learned that, for the estimated pose of the entity controller in the present application, not only the associated part pose may be observed, but also the relative pose relationship between the entity controller and the associated part may be obtained, or may be determined by inertial data within a certain time interval.

Therefore, in order to ensure the accurate positioning of the entity controller, the estimated pose of the entity controller in the present application may be determined by determining the estimated pose of the entity controller based on the relative pose relationship, the current associated part pose and a first confidence, and a previous estimated pose of the entity controller, the inertial data and a second confidence.

In other words, considering that the inertial data obtained by the entity controller through the IMU can only ensure the positioning accuracy in a short period, and a long-term positioning accuracy of the entity controller cannot be ensured. Therefore, as shown in FIG. 2, when the associated part pose is observed, and the entity controller pose is analyzed in combination with the relative pose relationship between the entity controller and the associated part, the entity controller pose may also be optimized by combining the inertial data in a time interval detected by the IMU for the entity controller, thereby improving the positioning accuracy of the entity controller.

In one aspect, a first pose of the entity controller at the capture time of the current second type of image may be determined by observing the current associated part pose in the current second type of image that is closest to the current, and in combination with the relative pose relationship between the entity controller and the associated part. Moreover, by analyzing the positioning accuracy of the image positioning algorithm used for the current associated part pose, a confidence of the image positioning algorithm for the current associated part pose may be determined as the first confidence in the present application.

On the other hand, since the estimated pose of the entity controller is determined in real time in the motion process of the entity controller, the previous estimated pose of the entity controller that has been previously determined may be obtained at the capture time of the current second type of image.

In one case, if no light spot is detected in a previous first type of image before the current second type of image that is closest to the current, the previous estimated pose of the entity controller may be determined from the relative pose relationship between the associated part pose and the associated part pose in a previous second type of image before the current second type of image that is closest to the current.

In another case, if a light spot has been detected in the previous first type of image before the current second type of image that is closest to the current, the previous estimated pose of the entity controller may be determined from an optical positioning result of the entity controller in the previous first type of image before the current type of image that is closest to the current.

Then, on the basis of the previous estimated pose of the entity controller, the inertial data between a moment at which the previous estimated pose of the entity controller pose is located and the capture time of the current second type of image may be obtained from the IMU. Then, a second pose of the entity controller at the capture time of the current second type of image may be determined based on the previous estimated pose of the entity controller and an integration of the inertial data. Moreover, by analyzing the positioning accuracy of the inertial data of the IMU, the confidence that the IMU is located with respect to the entity controller may be determined as the second confidence in the present application.

Then, using the first confidence and the second confidence, weighted fusion is performed on the first pose and the second pose of the entity controller at the capture time of the current second type of image, respectively, to obtain the estimated pose of a corresponding entity controller.

As an example solution in the present application, in order to ensure the positioning accuracy of the entity controller, the present application may introduce an Extended Kalman Filter (EKF) algorithm, or an Error State Kalman Filter (ESKF) algorithm. The EKF algorithm and the ESKF algorithm are both set with corresponding weights for the entity controller pose obtained in different manners, that is, the first confidence and the second confidence mentioned above. In other words, using the EKF algorithm and the ESKF algorithm, the entity controller pose obtained in different manners may be fused to obtain a final estimated pose of the entity controller, to ensure the accuracy of the position of the entity controller.

Therefore, the present application may directly input the relative pose relationship between the entity controller and the associated part and the current associated part pose, and the inertial data continuously captured between the previous estimated pose of the entity controller and the capture time corresponding to the pose of the previous entity controller to collect capture time corresponding to the current associated part pose, and uniformly input the inertial data into the EKF algorithm or the ESKF algorithm.

Then, in the EKF algorithm or the ESKF algorithm, the entity controller pose in one calculation manner may be determined by using the relative pose relationship and the current associated part pose. The entity controller pose in another calculation manner is determined by using the previous estimated pose of the entity controller and the captured inertial data. Then, the estimated pose of the entity controller may be obtained by fusing the entity controller pose determined in foregoing two manners by using the EKF algorithm or each weight preset in the ESKF algorithm.

It can be learned from foregoing content that, the estimated pose of the entity controller determined each time in the present application may be pose information of the entity controller at the capture time from the current second type of image that is closest to the current.

As an optional implementation solution of the present application, different exposure policies may be used in the present application to separately capture the first type of image and the second type of image. When the first type of image includes the light spot formed by the light emitting element, an optical positioning algorithm may be used to determine the pose of the corresponding entity controller.

Therefore, when the association part of the entity controller is positioning by using the second type of image captured each time, the present application may further determine a current entity controller pose, the current entity controller pose is determined based on the current first type of image that is closest to the current.

That is, a current first type of image that is closest to the current is captured based on a captured capture time of each first type of image. Then, when the light spot formed by the light-emitting element is included in the current first type of image, an optical positioning algorithm may be used to perform positioning and tracking on the entity controller in the current first type of image, to obtain a corresponding current entity controller pose.

Therefore, considering that the associated part in the current second type of image may be captured unclear, the current associated part pose is inaccurate, resulting in inaccurate estimated pose of the entity controller. Alternatively, the light spots formed by the light-emitting elements of the entity controller in the current first-class image are not clear, so that the current entity controller pose is inaccurate. Therefore, in order to ensure accurate positioning of the entity controller, the present application may further determine the estimated pose of the entity controller based on the relative pose relationship and the current associated part pose, the current entity controller pose, and the inertial data between the capture time of the current first-class image and the capture time of the current second type of image.

In other words, the pose transformation is performed on the current associated part pose determined based on the current second type of image that is closest to the current through the relative pose relationship between the entity controller and the associated part, to determine the pose information of the entity controller at the capture time of the current second type of image.

Moreover, after the current entity controller pose is determined based on the current first type of image that is closest to the current, the current entity controller pose may be pose information of the entity controller at the capture time of the current first type of image. Therefore, based on the current entity controller pose determined from the current latest first type of image and the obtained integration of the inertial data between the capture time of the current first type of image and the capture time of the current second type of image, another pose information of the entity controller at the capture time of the current second type of image may be determined. Further, the present application may fuse two pose information determined in different manners at the capture time of the current second type of image to obtain the estimated pose of the corresponding entity controller.

It should be noted that, for the estimate pose of the entity controller through the fused entity controller, a fused estimate pose of entity controller and the first confidence, and the previous estimate pose of entity controller, the inertial data, and the second confidence may be further used to re-update the estimated pose of the entity controller to ensure the positioning accuracy of the entity controller.

According to one or more embodiments of the present application, the IMU may generally detect a plurality of inertial data of the entity controller within a time interval between any two of the first type of image and the second type of image. Therefore, after determining the estimated pose of the entity controller, that is, the pose information of the entity controller at the capture time from the current second type of image that is closest to the current, the present application may further determine a real-time pose of the entity controller based on the estimated pose of the entity controller and the inertial data from the capture time of the current second type of image to the current time.

In other words, after the current second type of image is captured, the IMU may further detect a plurality of inertial data of the entity controller in real time. Then, the inertial data detected by the IMU on the entity controller from the capture time of the current second type of image to the current time is captured. Then, based on the pose information of the entity controller at the capture time of the current second type of image closest to the current, the real-time pose of the entity controller at the current time can be obtained by combining an integration processing of the inertial data from the capture time of the current second type of image to the current time.

As an optional implementation solution of the present application, considering that a time interval between any two images in the first type of image and the second type of image, the IMU may generally detect a plurality of inertial data of the entity controller. The relative pose relationship between the entity controller and the associated part may be determined from at least one entity controller pose determined based on the first type of image and at least one associated part pose determined from the second type of image.

In the present application, in the first type of image and the second type of image that are continuously capture, the entity controller pose may be continuously determined from the light spots in each of the first type of images, and the associated part pose is continuously determined based on each of the second type of images. Then, the relative pose relationship between the entity controller and the associated part may be determined from the at least one entity controller pose, the at least one associated part pose, and the inertial data between the capture time of the first type of image corresponding to the entity controller pose and the capture time of the second type of image corresponding to the associated part pose.

In other words, for the at least one entity controller pose and the at least one associated part pose, the present application may directly obtain the inertial data between the capture time of the first type of image corresponding to the entity controller pose and the capture time of the second type of image corresponding to the associated part pose detected by the IMU for the entity controller.

Then, according to the front-back capture relationship between the at least one entity controller pose and the at least one associated part pose, the integration processing of the inertial data may be combined based on the entity controller pose and the associated part pose, to obtain the entity controller pose and the associated part pose at a same moment, so as to determine the relative pose relationship between the two.

In some implementations, for the at least one associated part pose determined based on the second type of image, the associated part pose may be determined based on an entity region of interest in the second type of image, and a region of interest area in the second type of image may be determined based on the pose controller pose corresponding to the previous first type of image of the second type of image and the inertial data between the capture time of the previous first type of image and the capture time of the second type of image.

That is, because the entity controller is worn or held on the associated part, spatial poses of the two are different. The IMU on the entity controller detects the inertial data of the entity controller in real time, and obtains the real-time inertial pose of the entity controller with higher precision. Therefore, for each captured second type of image, the present application may use an optical positioning algorithm to process the light spot information in the previous first type of image of the second type of image to obtain the pose information of the entity controller at the capture time of the previous first type of image. Then, inertial data between the capture time of the previous first type of image and the capture time of the second type of image is obtained, and pose information of the entity controller at the capture time of the second type of image can be obtained based on the pose information of the entity controller at the capture time of the previous first type of image and the integration of the inertial data between the capture time of the previous first type of image and the capture time of the second type of image.

Then, the present application may analyze the pose information of the entity controller at the capture time of the second type of image to determine a general area where the entity controller is located in the second type of image, to determine the entity region of interest in the second type of image.

Furthermore, since the entity controller is worn or held on the associated part, the spatial pose difference between the two is different. Considering that a performance of a gesture recognition algorithm itself is large, if the gesture recognition algorithm is executed in the whole region of the second type of image, a larger performance cost is caused. Therefore, after determining the entity region of interest in the second type of image, it may be learned that the entity region of interest may include an association part of the entity controller. Therefore, the feature analysis of the associated part of the entity region of interest may be performed to extract the key point features of the associated part without feature analysis of the associated part of the whole second type of image, and the gesture recognition algorithm is executed in the entity region of interest to greatly save performance consumption.

Then, through the image positioning algorithm, corresponding positioning analysis may be performed on the key point features of the associated part to determine the pose information of the associated part in the second type of image, to obtain the pose of the at least one associated part in the present application, to ensure stability of the positioning of the associated part, to improve the positioning stability of the entity controller when being occlusion.

According to the technical scheme provided by the embodiments of the present application, the associated part of the entity controller in the at least one second type of image is positioned and tracked, so that the positioning of the entity controller when the entity controller is occlusion is assisted, the positioning blind area when the entity controller is occlusion is reduced, the positioning accuracy and stability of the associated part are improved, and the positioning accuracy and stability of the entity controller are ensured.

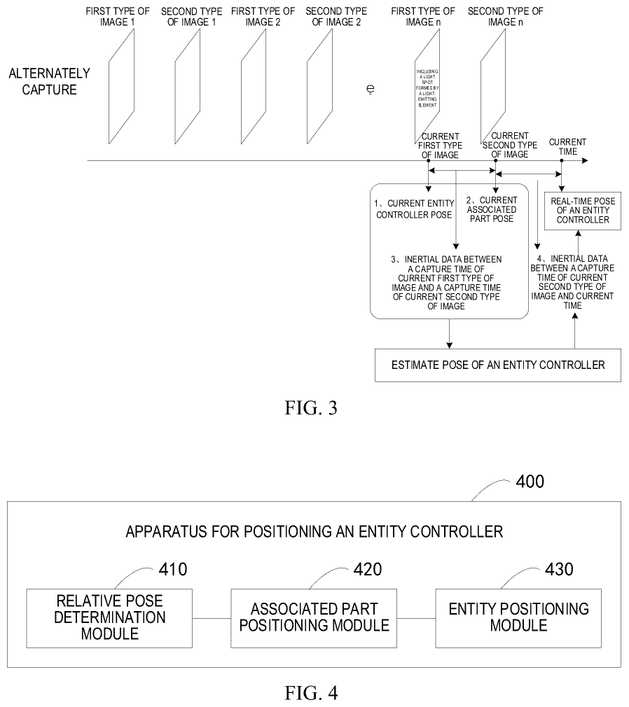

According to one or more embodiments of the present application, due to the relative pose relationship between the entity controller and the associated part, it is usually necessary to determine the pose information at the same moment by analyzing the two. Cameras on the head-mounted display cannot capture the first type of image and the second type of image at the same time by using two different exposure policies at the same moment. Therefore, in order to avoid a problem that the relative pose relationship between the entity controller and the entity controller is inaccurate due to existence of a larger pose transformation error when the pose information of the associated parts of the entity controller and the entity controller at different moments is transformed to the same moment, as shown in FIG. 3, the first type of image and the second type of image in the present application may be alternately capture based on a preset frequency.

Therefore, the relative pose relationship between the entity controller and the associated part in the present application may be determined from the at least one entity controller pose, the at least one associated part pose, and the inertial data between the capture time of the first type of image corresponding to the entity controller pose and the capture time of the second type of image corresponding to the associated part pose.

The acquisition frequency of the IMU for the inertial data of the entity controller may be higher than the acquisition frequency of the first type of image and/or the second type of image.

Moreover, in order to avoid the error caused by the pose transformation between the entity controller and the associated part due to the pose transformation of the entity controller and the associated part at different moments, the capture time of the first type of image corresponding to the entity controller pose and the capture time of the second type of image corresponding to the associated part pose are adjacent to the at least one entity controller pose and the at least one associated part pose used by the relative pose relationship.

That is, for every two adjacent first type of images and second type of images, the first type of image may include a light spot formed by the light-emitting element. Then, the present application may use an optical positioning algorithm to perform positioning analysis on the light spot in the first type of image to determine the corresponding entity controller pose. Moreover, the present application may further use an image positioning algorithm to perform positioning analysis on the associated part of the entity controller in the second type of image to determine the corresponding pose of the associated part.

Then, a plurality of inertial data detected by the IMU between two adjacent capture times of the first type of image and the second type of image is captured. According to the foregoing sequential capture relationship between the first type of image and the second type of image, the entity controller pose and the associated part pose at the same moment may be obtained based on the pose information of the entity controller and the integration of the plurality of pieces of inertial data detected between two adjacent capture times of the first type of image and the second type of image respectively determined based on the adjacent first type of image and the second type of image, to obtain the corresponding relative pose relationship.

It can be understood that, since the first type of image and the second type of image are alternately capture in the present application, the entity controller pose in the first type of image and the associated part pose in the second type of image are continuously determined. Therefore, the relative pose relationship between the entity controller and the associated part of the entity controller can be continuously updated by continuously analyzing the entity controller pose and the pose of the associated part at the adjacent moment and the plurality of inertial data detected by the IMU in the adjacent time period, so that accuracy of the relative pose relationship is ensured, and accurate positioning of the entity controller is further improved.

For the positioning process of the entity controller, as shown in FIG. 3, the present application may be adjacent to the current first type of image that is closest to the current and the current second type of image. Then, the current entity controller pose may be determined based on the current first-class image, and the current associated part pose may be determined based on the current second type of image. The pose information of the entity controller at the capture time of the current second type of image may be obtained by using the current entity controller pose and the integration of the inertial data between the capture time of the current first type of image and the capture time of the current second type of image. Then, based on the pose information of the entity controller at the capture time of the current second type of image and the current associated part pose, a latest relative pose relationship between the entity controller and the associated part may be determined.

Further, the pose transformation is performed on the current associated part pose based on the latest relative pose relationship, to determine the estimated pose of the entity controller. Then, the real-time pose of the entity controller can be determined based on the estimated pose of the entity controller and the integration of the inertial data from the capture time of the current second type of image to the current time, thereby realizing accurate positioning of the entity controller.

According to the technical scheme provided by the embodiments of the present application, in the alternating acquisition process of the first type of image and the second type of image, the relative pose relation between the associated part of the entity controller and the entity controller is continuously updated, and the positioning accuracy when the entity controller is occlusion is improved.

FIG. 4 is a schematic block diagram of an apparatus for positioning an entity controller provided by embodiments of the present application. As shown in FIG. 4, the apparatus 400 for positioning the entity controller may include:
a relative pose determination module 410, configured to determine a relative pose relationship between the entity controller and an associated part of the entity controller, the relative pose relationship is determined from at least one entity controller pose and at least one associated part pose, the entity controller pose is determined from a first type of image, the associated part pose is determined from a second type of image, and the first type of image and the second type of image use different exposure policies;
an associated part positioning module 420, configured to determine a current associated part pose, the current associated part pose is determined based on a current second type of image that is closest to the current; and
an entity positioning module 430, configured to determine an estimated pose of the entity controller based on the relative pose relationship and the current associated part pose.

In some implementable manners, the entity controller is provided with a light-emitting element, the first type of image includes a light spot formed by the light-emitting element, and the entity controller pose is determined from a light spot in the first type of image.

In some implementations, the entity positioning module 430 may be specifically configured to:
determine the estimated pose of the entity controller based on the relative pose relationship, the current associated part pose and a first confidence, and a previous estimated pose of the entity controller, inertial data and a second confidence.

In some implementations, the entity positioning module 430 may be further configured to:
determine a current entity controller pose, the current entity controller pose being determined based on a current first type of image that is closest to the current.

In some implementations, the entity positioning module 430 may be further configured to:
determine the estimated pose of the entity controller based on the relative pose relationship and the current associated part pose, the current entity controller pose, and inertial data between a capture time of the current first type of image and a capture time of the current second type of image.

In some implementations, the apparatus 400 for positioning the entity controller may further include:
an entity real-time positioning module, configured to determine a real-time pose of the entity controller based on the estimated pose of the entity controller and inertial data between a capture time of the current second type of image and a current time.

In some implementations, the associated part pose is determined based on an entity region of interest in the second type of image, and the entity region of interest in the second type of image is determined based on an entity controller pose corresponding to a previous first type of image of the second type of image and inertial data between a capture time of the previous first type of image and a capture time of the second type of image.

In some implementations, the relative pose relationship is determined from at least one entity controller pose, at least one associated part pose, and inertial data between a capture time of a first type of image corresponding to the entity controller pose and a capture time of a second type of image corresponding to the associated part pose.

In some implementations, the first type of image and the second type of image are alternately captured at a predetermined frequency.

In some implementations, the relative pose relationship is determined from at least one entity controller pose, at least one associated part pose, and inertial data between a capture time of a first type of image corresponding to the entity controller pose and a capture time of a second type of image corresponding to the associated part pose, and a capture time of the first type of image corresponding to the entity controller pose and the capture time of the second type of image corresponding to the associated part pose are adjacent.

In some implementations, the inertial data are inertial data of the entity controller, and a capture frequency of the inertial data is higher than a capture frequency of the first type of image and/or the second type of image.

In the embodiment of the present application, the first type of image and the second type of image are determined by using different exposure policies, and the relative pose relation between the entity controller and the associated part of the entity controller is determined from at least one entity controller pose determined based on the first type of image and at least one associated part pose determined based on the second type of image. Then, the current associated part pose is determined based on the current second type of image that is closest to the current, so that the estimated pose of the entity controller is determined based on the relative pose relationship and the current associated part pose, accurate positioning of the entity controller is achieved, the position that the entity controller cannot be positioned when the entity controller is occlusion is avoided, the associated part positioning the entity controller is combined, the wider positioning range is provided for the entity controller, the positioning blind area when the entity controller is occlusion is reduced, and the stability and the comprehensiveness of positioning of the entity controller are improved.

It should be understood that apparatus embodiment and method embodiments in the present application may correspond to each other, and similar descriptions may refer to the method embodiments in the present application. To avoid repetition, details are not described herein again.

Specifically, the apparatus 400 shown in FIG. 4 may perform any method embodiment provided in the present application, and the foregoing and other operations and/or functions of each module in the apparatus 400 shown in FIG. 4 are respectively used to implement corresponding processes of the foregoing method embodiments.

The foregoing method embodiments of the embodiments of the present application are described above with reference to a perspective of a functional module in combination with the drawings. It should be understood that the functional module may be implemented in hardware, or may be implemented by using instructions in a form of software, or may be implemented by combining hardware and software modules. Specifically, steps in the method embodiment in embodiments of the present application may be completed by using an integrated logic circuit of hardware in a processor and/or an instruction in a form of software, and steps of the method disclosed in embodiments of the present application may be directly reflected as execution of a hardware decoding processor, or performed by combining hardware and the software modules in a decoding processor. Optionally, the software modules may be located in a mature storage medium in the art such as a random access memory, a flash memory, a read-only memory, a programmable read-only memory, an electrically erasable programmable memory, a register, and the like. The storage medium is located in the memory, the processor reads information in the memory, and completes the steps in foregoing method embodiments in combination with hardware of the storage medium.

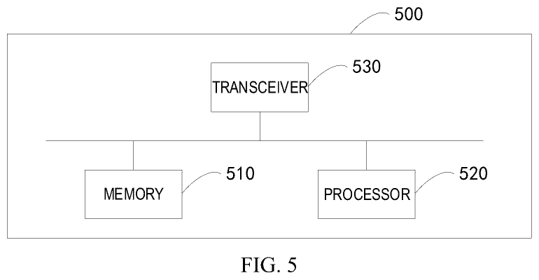

FIG. 5 is a schematic block diagram of an electronic device provided by embodiments of the present application.

As shown in FIG. 5, the electronic device 500 may include:
a memory 510 and processor 520, the memory 510 is configured to store a computer program, and transmit the program code to the processor 520. In other words, the processor 520 may invoke and run the computer program from the memory 510 to implement the method in embodiments of the present application.

For example, the processor 520 may be configured to perform the foregoing method embodiments based on the instructions in the computer program.

In some embodiments of the present application, the processor 520 may include, but is not limited to:

A general-purpose processor, a Digital Signal Processor (DSP), an Application Specific Integrated Circuit (ASIC), a Field Programmable Gate Array (FPGA), another programmable logic device, a discrete gate or transistor logic device, a discrete hardware component, or the like.

In some embodiments of the present application, the memory 510 includes, but is not limited to:
volatile memory and/or non-volatile memory. The non-volatile memory may be a Read-Only Memory (ROM), a Programmable Read-Only Memory (Programmable ROM, PROM), an Erasable Programmable Read-Only Memory (Erasable PROM, EPROM), an Electrically Erasable Programmable Read-Only Memory (Electrically EPROM, EEPROM), or a flash memory. The volatile memory may be a Random Access Memory (RAM), which serves as an external cache. By way of example and not limitation, many forms of RAM are available, such as Static Random Access Memory (Static RAM, SRAM), Dynamic Random Access Memory (Dynamic RAM, DRAM), Synchronous Dynamic Random Access Memory (SDRAM), (Double Data Rate SDRAM, DDR SDRAM), Enhanced SDRAM (ESDRAM), Synch link DRAM (SLDRAM), and Direct Rambus RAM (DR RAM).

In some embodiments of the present application, the computer program may be divided into one or more modules, and the one or more modules are stored in the memory 510 and executed by the processor 520 to complete the method provided in the present application. The one or more modules may be a series of computer program instructions segments capable of completing a specific function, and the instructions segments are used to describe an execution process of the computer program in the electronic device 500.

As shown in FIG. 5, the electronic device may further include:
a transceiver 530 may be connected to the processor 520 or the memory 510.

The processor 520 may control the transceiver 530 to communicate with another device, specifically, may send information or data to another device, or receive information or data sent by another device. The transceiver 530 may include a transmitter and a receiver. The transceiver 530 may further include an antenna, and there may be one or more antennas.

It should be understood that each component in the electronic device 500 is connected to the bus system, where the bus system includes, moreover to a data bus, a power bus, a control bus, and a status signal bus.

The present application further provides a computer storage medium, where a computer program is stored, and when the computer program is executed by a computer, the computer can perform the method in the foregoing method embodiments.

An embodiment of the present application further provides a computer program product including a computer program/instructions, where the computer program/instructions, when executed by a computer, causes the computer to perform the method in the foregoing method embodiments.

When implemented using software, it may be implemented in whole or in part in the form of a computer program product. The computer program product includes one or more computer instructions. When the computer program instructions are loaded and executed on a computer, the processes or functions according to the embodiments of the present application are all or partially generated. The computer may be a general purpose computer, a special purpose computer, a computer network, or other programmable device. The computer instructions may be stored in a computer-readable storage medium or transmitted from one computer-readable storage medium to another computer-readable storage medium, for example, the computer instructions may be transmitted from a website site, a computer, a server, or a data center to another website site, computer, server, or data center over a wired (e.g., coaxial cable, optical fiber, digital subscriber line (DSL)) or wireless (e.g., infrared, wireless, microwave, etc.). The computer-readable storage medium may be any available medium that can be accessed by a computer or a data storage device such as a server or a data center integrated with one or more available media. The usable medium may be a magnetic medium (for example, a floppy disk, a hard disk, a magnetic tape), an optical medium (for example, a Digital Video Disc (DVD)), a semiconductor medium (for example, a Solid State Disk (SSD)), or the like.

The foregoing is only a specific implementations of the present application, but the protection scope of the present application is not limited thereto, and any person skilled in the art can easily conceive of variations or replacements within the technical scope of the present application, and should be covered within the protection scope of the present application. Therefore, the protection scope of the present application should be based on the protection scope of the claims.

I/We claim:

1. A method for positioning an entity controller, comprising:
determining a relative pose relationship between the entity controller and an associated part of the entity controller, the relative pose relationship being determined from at least one entity controller pose and at least one associated part pose, the entity controller pose being determined from a first type of image, the associated part pose being determined from a second type of image, and the first type of image and the second type of image using different exposure policies;
determining a current associated part pose, the current associated part pose being determined based on a current second type of image that is closest to the current;
determining an estimated pose of the entity controller based on the relative pose relationship and the current associated part pose.

2. The method of claim 1, wherein the entity controller is provided with a light-emitting element, the first type of image comprises a light spot formed by the light-emitting element, and the entity controller pose is determined from the light spot in the first type of image.

3. The method of claim 1, wherein the determining an estimated pose of the entity controller based on the relative pose relationship and the current associated part pose comprises:
determining the estimated pose of the entity controller based on the relative pose relationship, the current associated part pose and a first confidence, and a previous estimated pose of the entity controller, inertial data and a second confidence.

4. The method of claim 1, further comprises:
determining a current entity controller pose, the current entity controller pose being determined based on a current first type of image that is closest to the current;
the determining an estimated pose of the entity controller based on the relative pose relationship and the current associated part pose comprises:
determining the estimated pose of the entity controller based on the relative pose relationship and the current associated part pose, the current entity controller pose, and inertial data between a capture time of the current first type of image and a capture time of the current second type of image.

5. The method of claim 1, further comprises:
determining a real-time pose of the entity controller based on the estimated pose of the entity controller and inertial data between a capture time of the current second type of image and a current time.

6. The method of claim 1, wherein the associated part pose is determined based on an entity region of interest in the second type of image, and the entity region of interest in the second type of image is determined based on an entity controller pose corresponding to a previous first type of image of the second type of image and inertial data between a capture time of the previous first type of image and a capture time of the second type of image.

7. The method of claim 1, wherein the relative pose relationship is determined from at least one entity controller pose, at least one associated part pose, and inertial data between a capture time of a first type of image corresponding to the entity controller pose and a capture time of a second type of image corresponding to the associated part pose.

8. The method of claim 1, wherein the first type of image and the second type of image are alternately captured at a predetermined frequency.

9. The method of claim 8, wherein the relative pose relationship is determined from at least one entity controller pose, at least one associated part pose, and inertial data between a capture time of a first type of image corresponding to the entity controller pose and a capture time of a second type of image corresponding to the associated part pose, and the capture time of the first type of image corresponding to the entity controller pose and the capture time of the second type of image corresponding to the associated part pose are adjacent.

10. The method of claim 9, wherein the inertial data are inertial data of the entity controller, and a capture frequency of the inertial data is higher than a capture frequency of the first type of image and/or the second type of image.

11. An electronic device, comprising:
a processor; and
a memory for storing executable instructions for the processor;
wherein the processor is configured to perform, by executing the executable instructions, a method comprising:
determining a relative pose relationship between the entity controller and an associated part of the entity controller, the relative pose relationship being determined from at least one entity controller pose and at least one associated part pose, the entity controller pose being determined from a first type of image, the associated part pose being determined from a second type of image, and the first type of image and the second type of image using different exposure policies;
determining a current associated part pose, the current associated part pose being determined based on a current second type of image that is closest to the current;
determining an estimated pose of the entity controller based on the relative pose relationship and the current associated part pose.

12. The electronic device of claim 11, wherein the entity controller is provided with a light-emitting element, the first type of image comprises a light spot formed by the light-emitting element, and the entity controller pose is determined from the light spot in the first type of image.

13. The electronic device of claim 11, wherein the determining an estimated pose of the entity controller based on the relative pose relationship and the current associated part pose comprises:
determining the estimated pose of the entity controller based on the relative pose relationship, the current associated part pose and a first confidence, and a previous estimated pose of the entity controller, inertial data and a second confidence.

14. The electronic device of claim 11, further comprises:
determining a current entity controller pose, the current entity controller pose being determined based on a current first type of image that is closest to the current;
the determining an estimated pose of the entity controller based on the relative pose relationship and the current associated part pose comprises:
determining the estimated pose of the entity controller based on the relative pose relationship and the current associated part pose, the current entity controller pose, and inertial data between a capture time of the current first type of image and a capture time of the current second type of image.

15. The electronic device of claim 11, further comprises:
determining a real-time pose of the entity controller based on the estimated pose of the entity controller and inertial data between a capture time of the current second type of image and a current time.

16. The electronic device of claim 1, wherein the associated part pose is determined based on an entity region of interest in the second type of image, and the entity region of interest in the second type of image is determined based on an entity controller pose corresponding to a previous first type of image of the second type of image and inertial data between a capture time of the previous first type of image and a capture time of the second type of image.

17. The electronic device of claim 11, wherein the relative pose relationship is determined from at least one entity controller pose, at least one associated part pose, and inertial data between a capture time of a first type of image corresponding to the entity controller pose and a capture time of a second type of image corresponding to the associated part pose.

18. The electronic device of claim 11, wherein the first type of image and the second type of image are alternately captured at a predetermined frequency.

19. The electronic device of claim 18, wherein the relative pose relationship is determined from at least one entity controller pose, at least one associated part pose, and inertial data between a capture time of a first type of image corresponding to the entity controller pose and a capture time of a second type of image corresponding to the associated part pose, and the capture time of the first type of image corresponding to the entity controller pose and the capture time of the second type of image corresponding to the associated part pose are adjacent.

20. A computer-readable storage medium having a computer program stored thereon, wherein the computer program, when executed by a processor, implements a method comprising:
determining a relative pose relationship between the entity controller and an associated part of the entity controller, the relative pose relationship being determined from at least one entity controller pose and at least one associated part pose, the entity controller pose being determined from a first type of image, the associated part pose being determined from a second type of image, and the first type of image and the second type of image using different exposure policies;
determining a current associated part pose, the current associated part pose being determined based on a current second type of image that is closest to the current;
determining an estimated pose of the entity controller based on the relative pose relationship and the current associated part pose.
